(19) United States
(12) Patent Application Publication
(10) Pub. No.: US 2008/0102924 A1
(43) Pub. Date: May 1, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/785,986

(22) Filed: Apr. 23, 2007

Related U.S. Application Data
(60) Provisional application No. 60/854,069, filed on Oct. 25, 2006.

(51) Int. Cl. A63F 13/00

(52) U.S. Cl. 463/20; 463/16

(57) ABSTRACT

A slot machine which differentiates display of symbols satisfying a condition for payout among several types of symbols arranged on a display from display of the other symbols and rearranges the symbols other than the symbols satisfying the condition for payout.

### CROSS-REFERENCE TO RELATED APPLICATION

This application is based upon and claims the benefit of U.S. Provisional Application No. 60/854,069, filed on Oct. 25, 2006; the entire contents of which are incorporated herein by reference.

### BACKGROUND OF THE INVENTION

1. Field of the Invention

The present invention relates to a slot machine and a playing method thereof.

2. Description of the Related Art

There is a conventional slot machine known, as disclosed in the US Patent U.S. Pat. No. 6,604,999B2, which makes a payout for rearrangement of a winning combination on a payline of a display or for rearrangement of a predetermined number of predetermined symbols on the display.

Moreover, the US Patent No. U.S. Pat. No. 6,093,102A discloses a slot machine which makes a payout when the winning combination is rearranged on a payline whose patterns can be increased in number by player's selection.

For such conventional slot machines, a slot machine including new entertainment is desired to appear.

### SUMMARY OF THE INVENTION

A first aspect of the present invention is a slot machine including: a display on which arranged several types of symbols are rearranged; and a controller which differentiates display of symbols satisfying a condition for payout among the several types of arranged symbols from display of the other symbols and rearranges the symbols other than the symbols satisfying the condition for payout. In this slot machine, the symbols other than the symbols satisfying the condition for payout are rearranged, and the symbols satisfying the condition for payout are not rearranged and carried over to the next play. The display of the symbols satisfying the condition for payout is differentiated from the display of the other symbols.

A second aspect of the present invention is a slot machine including: a display on which arranged several types of symbols are rearranged at each of a plurality of plays; and a controller which repeats rearrangement of symbols other than symbols satisfying a condition for payout among the several types of arranged symbols at the plurality of plays and changes display of the symbols satisfying the condition for payout to display according to the number of remaining plays in which the rearrangement of the other symbols is repeated. In this slot machine, the symbols other than the symbols satisfying the condition for payout are rearranged, and the symbols satisfying the condition for payout are not rearranged and carried over to the next play. Such carry over to the next play is executed over several plays. The display of the symbols satisfying the condition for payout changes depending on the number of remaining plays.

A third aspect of the present invention is a slot machine including: a display on which arranged several types of symbols are rearranged; a controller which differentiates display of symbols satisfying a condition for payout among the several types of arranged symbols from display of the other symbols and executes a special game in which the rearrangement of the symbols other than the symbols satisfying the condition for payout is repeated; and a switch to terminate the special game. In this slot machine, the symbols other than the symbols satisfying the condition for payout are rearranged, and the symbols satisfying the condition for payout are not rearranged and carried over to the next play. The display of the symbols satisfying the condition for payout is differentiated from the display of the other symbols. Such a difference in display serves as information allowing the player to make a decision whether to terminate the special game in which the other symbols are rearranged. The special game is terminated by an operation of the switch.

A fourth aspect of the present invention is a slot machine including: a display on which arranged several types of symbols are rearranged at each of a plurality of plays; a controller which executes a special game in which rearrangement of symbols other than the symbols satisfying a condition for payout among the several types of symbols is repeated at the plurality of plays and changes display of the symbols satisfying the condition for payout to display according to the number of remaining plays in which the rearrangement of the other symbols is repeated; and a switch to terminate the special game. In this slot machine, the symbols other than the symbols satisfying the condition for payout are rearranged, and the symbols satisfying the condition for payout are not rearranged and carried over to the next play. Such carry over to the next game is executed over several plays. The display of the symbols satisfying the condition for payout changes according to the number of remaining plays to which the symbols are carried over. Such a change in display serves as information allowing the player to make a decision whether to terminate the special game in which the other symbols are rearranged. The special game is terminated by an operation of the switch.

A fifth aspect of the present invention is a slot machine including: a display on which arranged several types of symbols are rearranged; and a controller which differentiates brightness of symbols satisfying a condition for payout among the several types of arranged symbols from brightness of the other symbols and rearranges the symbols other than the symbols satisfying the condition for payout. In this slot machine, the symbols other than the symbols satisfying the condition for payout are rearranged, and the symbols satisfying the condition for payout are not rearranged and carried over to the next play. The brightness of the symbols satisfying the condition for payout is differentiated from the brightness of the other symbols.

A sixth aspect of the present invention is a slot machine including: a display on which several types of arranged symbols are rearranged at each of a plurality of plays; and a controller which repeats the rearrangement of symbols other than symbols satisfying a condition for payout among the several types of arranged symbols at the plurality of plays and changes color of the symbols satisfying the condition for payout to a color according to the number of remaining plays in which the rearrangement of the other symbols is repeated. In this slot machine, the symbols other than the symbols satisfying the condition for payout are rearranged, and the symbols satisfying the condition for payout are not rearranged and carried over to the next play. Such carry over to the next play is executed over several plays. The color of symbols satisfying the condition for payout changes according to the number of remaining plays to which the symbols are carried over.

A seven aspect of the present invention is a slot machine including: a display on which several types of arranged symbols are rearranged; a controller which differentiates brightness of symbols satisfying a condition for payout among the several types of arranged symbols from brightness of the other symbols and executes a special game in which the symbols other than the symbols satisfying the condition for payout are rearranged; and a switch to terminate the special game. In this slot machine, the symbols other than the symbols satisfying the condition for payout are rearranged, and the symbols satisfying the condition for payout are not rearranged and carried over to the next play. The brightness of the symbols satisfying the condition for payout is differentiated from the brightness of the other symbols. Such a difference in brightness serves as information allowing the player to make a decision whether to terminate the special game in which the other symbols are rearranged. The special game is terminated by an operation of the switch.

An eighth embodiment of the present invention is a slot machine including: a display on which several types of arranged symbols are rearranged at each of a plurality of plays; and a controller which executes a special game in which rearrangement of symbols other than the symbols satisfying the condition for payout among the several types of arranged symbols is repeated at the plurality of plays and changes color of the symbols satisfying the condition for payout to a color according to the number of remaining plays in which the rearrangement of the other symbols is repeated; and a switch to terminate the special game. In this slot machine, the symbols other than the symbols satisfying the condition for payout are rearranged, and the symbols satisfying the condition for payout are not rearranged and carried over to the next play. Such carry over to the next play is executed over several plays. The color of symbols satisfying the condition for payout changes according to the number of remaining plays to which the symbols are carried over. Such a change in color serves as information allowing the player to make a decision whether to terminate the special game in which the other symbols are rearranged. The special game is terminated by the operation of the switch.

A ninth aspect of the present invention is a slot machine including: a display on which several types of arranged symbols are rearranged in a first region; and a controller which displays a same symbol as symbols satisfying a condition for payout among the several types of arranged symbols in a second region which is different from the first region in addition to the first region and rearranges the symbols other than the symbols satisfying the condition for payout in the first region. In this slot machine, the symbols other than the symbols satisfying the condition for payout are rearranged, and the symbols satisfying the condition for payout are not rearranged and carried over to the next play. In addition to the first region where the symbols are rearranged, the same symbol as the symbols satisfying the condition for payout is displayed in the second region, which is different from the first region, so that the display of the symbols satisfying the condition for payout is differentiated from the display of the other symbols.

A tenth aspect of the present invention is a slot machine including: a display on which several types of arranged symbols are rearranged; and a controller which differentiates display of display regions where symbols satisfying a condition for payout among the several types of arrange symbols from display of display regions where the other symbols are arranged and rearranges the symbols other than the symbols satisfying the condition for payout. In this slot machine, the symbols other than the symbols satisfying the condition for payout are rearranged, and the symbols satisfying the condition for payout are not rearranged and carried over to the next play. The display of the display regions where the symbols satisfying the condition for payout are arranged is differentiated from the display of the display regions where the other symbols are arranged.

An eleventh aspect of the present invention is a playing method of a slot machine including the steps of: rearranging several types of symbols arranged on a display; differentiating display of symbols satisfying a condition for payout among the several types of arranged symbols from display of the other symbols; and rearranging the symbols other than the symbols satisfying the condition for payout. In this playing method of a slot machine, the symbols other than the symbols satisfying the condition for payout are rearranged, and the symbols satisfying the condition for payout are not rearranged and carried over to the next play. The display of the symbols satisfying the condition for payout is differentiated from the display of the other symbols.

A twelfth aspect of the present invention is a playing method of a slot machine including the steps of: rearranging several types of symbols arranged on a display at each of a plurality of plays; repeating rearrangement of symbols other than symbols satisfying a condition for payout among the several types of arranged symbols at the plurality of plays; and changing display of the symbols satisfying the condition for payout to display according to the number of remaining plays in which the rearrangement of the other symbols is repeated. In this playing method of a slot machine, the symbols other than the symbols satisfying the condition for payout are rearranged, and the symbols satisfying the condition for payout are not rearranged and carried over to the next play. Such carry over to the next play is executed over several plays. The display of the symbols satisfying the condition for payout changes depending on the number of remaining plays to which the symbols are carried over.

A thirteen aspect of the present invention is a playing method of a slot machine including the steps of: rearranging several types of symbols arranged on a display; differentiating display of symbols satisfying a condition for payout among the several types of arranged symbols from display of the other symbols; executing a special game in which the symbols other than the symbols satisfying the condition for payout are rearranged; and terminating the special game based on a predetermined input operation. In this playing method of a slot machine, the symbols other than the symbols satisfying the condition for payout are rearranged, and the symbols satisfying the condition for payout are not rearranged and carried over to the next play. The display of the symbols satisfying the condition for payout is differentiated from the display of the other symbols. Such a difference in display serves as information allowing the player to make a decision whether to terminate the special game in which the other symbols are rearranged. The special game is terminated by an operation of the switch.

A fourteenth aspect of the present invention is a playing method of a slot machine including the steps of: rearranging several types of symbols arranged on a display at each of a plurality of plays; executing a special game in which rearrangement of symbols other than symbols satisfying a condition for payout among the several types of arranged symbols is repeated at the plurality of plays; changing display of the symbols satisfying the condition for payout to display according to the number of remaining plays in which the rearrangement of the other symbols is repeated; and terminating the special game based on an input operation. In this playing method of a slot machine, the symbols other than the symbols satisfying the condition for payout are rearranged, and the symbols satisfying the condition for payout are not rearranged and carried over to the next play. Such carry over to the next play is executed over several plays. The display of the symbols satisfying the condition for payout changes according to the number of remaining plays to which the symbols are carried over. Such a change in display serves as information allowing the player to make a decision whether to terminate the special game in which the other symbols are rearranged. The special game is terminated by an operation of the switch.

A fifteenth aspect of the present invention is a playing method of a slot machine including the steps of: rearranging several types of symbols arranged on a display; differentiating brightness of symbols satisfying a condition for payout among the several types of arranged symbols from brightness of the other symbols; and rearranging the symbols other than the symbols satisfying the condition for payout. In this playing method of a slot machine, the symbols other than the symbols satisfying the condition for payout are rearranged, and the symbols satisfying the condition for payout are not rearranged and carried over to the next play. The brightness of the symbols satisfying the condition for payout is differentiated from the brightness of the other symbols.

A sixteenth aspect of the present invention is a playing method of a slot machine including the steps of: rearranging several types of symbols arranged on a display at each of a plurality of plays; repeating rearrangement of symbols other than symbols satisfying a condition for payout among the several types of arranged symbols at the plurality of plays; and changing color of the symbols satisfying the condition for payout into a color according to the number of remaining plays in which the rearrangement of the other symbols is repeated. In this slot machine, the symbols other than the symbols satisfying the condition for payout are rearranged, and the symbols satisfying the condition for payout are not rearranged and carried over to the next play. Such carry over to the next play is executed over several plays. The color of symbols satisfying the condition for payout changes according to the number of remaining plays to which the symbols are carried over.

A seventeenth aspect of the present invention is a playing method of a slot machine including the steps of: rearranging several types of symbols arranged on a display; differentiating brightness of symbols satisfying a condition for payout among the several types of arranged symbols from brightness of the other symbols; executing a special game in which the symbols other than the symbols satisfying the condition for payout are rearranged; and terminating the special game based on an input operation. In this playing method of a slot machine, the symbols other than the symbols satisfying the condition for payout are rearranged, and the symbols satisfying the condition for payout are not rearranged and carried over to the next play. The brightness of the symbols satisfying the condition for payout is differentiated from the brightness of the other symbols. Such a difference in brightness serves as information allowing the player to make a decision whether to terminate the special game in which the other symbols are rearranged. The special game is terminated by an operation of the switch.

An eighteenth aspect of the present invention is a playing method of a slot machine including the steps of: rearranging several types of symbols arranged on a display at each of a plurality of plays; executing a special game in which rearrangement of symbols other than symbols satisfying a condition for payout among the several types of arranged symbols is repeated at the plurality of plays; changing color of the symbols satisfying the condition for payout to a color according to the number of remaining plays in which the rearrangement of the other symbols is repeated; and terminating the special game based on a predetermined input operation. In this playing method of a slot machine, the symbols other than the symbols satisfying the condition for payout are rearranged, and the symbols satisfying the condition for payout are not rearranged and carried over to the next play. Such carry over to the next play is executed over several plays. The color of symbols satisfying the condition for payout changes according to the number of remaining plays to which the symbols are carried over. Such a change in color serves as information allowing the player to make a decision whether to terminate the special game in which the other symbols are rearranged. The special game is terminated by the operation of the switch.

A nineteenth aspect of the present invention is a playing method of a slot machine including the steps of: rearranging several types of symbols arranged in a first region of a display; displaying a same symbols as symbols satisfying a condition for payout among the several types of arranged symbols in a second region which is different from the first region in addition to the first region; and rearranging the symbols other than the symbols satisfying the condition for payout in the first region. In this playing method of a slot machine, the symbols other than the symbols satisfying the condition for payout are rearranged, and the symbols satisfying the condition for payout are not rearranged and carried over to the next play. In addition to the first region where the symbols are rearranged, the same symbol as the symbols satisfying the condition for payout is displayed in the second region, which is different from the first region, so that the display of the symbols satisfying the condition for payout is differentiated from the display of the other symbols.

A twentieth aspect of the present invention is a playing method of a slot machine including the steps of: rearranging several types of symbols arranged on a display; differentiating display of display regions where symbols satisfying a condition for payout are arranged among the several types of arranged symbols from display of display regions where the other symbols are arranged; and rearranging the symbols other than the symbols satisfying the condition for payout. In this playing method of a slot machine, the symbols other than the symbols satisfying the condition for payout are rearranged, and the symbols satisfying the condition for payout are not rearranged and carried over to the next play. The display of the display regions where the symbols satisfying the condition for payout are arranged is differentiated from the display of the display regions where the other symbols are arranged.

### BRIEF DESCRIPTION OF THE DRAWINGS

FIG. 1 is a flowchart showing a playing method of a slot machine according to an embodiment of the present invention.

FIG. 2 is a perspective view showing an appearance of the slot machine according to the embodiment of the present invention.

FIG. 3 is an explanatory view showing a display region of the slot machine according to the embodiment of the present invention.

FIG. 4 is a table showing symbols displayed at the slot machine according to the embodiment of the present invention and code numbers thereof.

FIG. 5 is a block diagram showing a control circuit of the slot machine according to the embodiment of the present invention.

FIG. 6 is an explanatory view showing a payout table referred by the slot machine according to the embodiment of the present invention.

FIG. 7 is a flowchart showing a procedure of a main process executed in the slot machine according to the embodiment of the present invention.

FIG. 8 is a flowchart showing a procedure of a slot game process executed in the slot machine according to the embodiment of the present invention.

FIG. 9 is a flowchart showing a procedure of a hold game determination process executed in the slot machine according to the embodiment of the present invention.

FIG. 10 is a schematic view showing a display example of symbols executed in the slot machine according to the embodiment of the present invention.

FIG. 11 is a flowchart showing a procedure of a symbol scroll display process held in the slot machine according to the embodiment of the present invention.

FIG. 12 is a schematic view showing a display state of symbols arranged in the slot machine according to the embodiment of the present invention.

FIG. 13 is a schematic view of a display state of symbols arranged in the slot machine according to the embodiment of the present invention.

FIG. 14 is a schematic view showing a display example of symbols held in the slot machine according to the embodiment of the present invention.

FIG. 15 is a schematic view showing a state where symbols are scrolling other than the symbols held in the slot machine according to the embodiment of the present invention.

FIG. 16 is a schematic view showing a state where symbols are rearranged in the slot machine according to the embodiment of the present invention.

FIG. 17 is a flowchart showing a procedure of a slot game process executed in a slot machine according to another embodiment of the present invention.

FIG. 18 is a schematic view showing a payline set in a slot machine according to another embodiment of the present invention.

FIG. 19 is a schematic view showing paylines set in a slot machine according to another embodiment of the present invention.

FIG. 20 is a schematic view showing paylines set in a slot machine according to another embodiment of the present invention.

FIG. 21 is a schematic view showing a display example of display regions of symbols held in a slot machine according to another embodiment of the present invention.

FIG. 22 is a schematic view showing a display example where the type of the held symbols is displayed outside of a reel frame in the slot machine according to another embodiment of the present invention.

FIG. 23 is a schematic view showing a display example where the type of the held symbols is displayed outside of a reel frame in a slot machine according to another embodiment of the present invention.

### DETAILED DESCRIPTION OF THE INVENTION

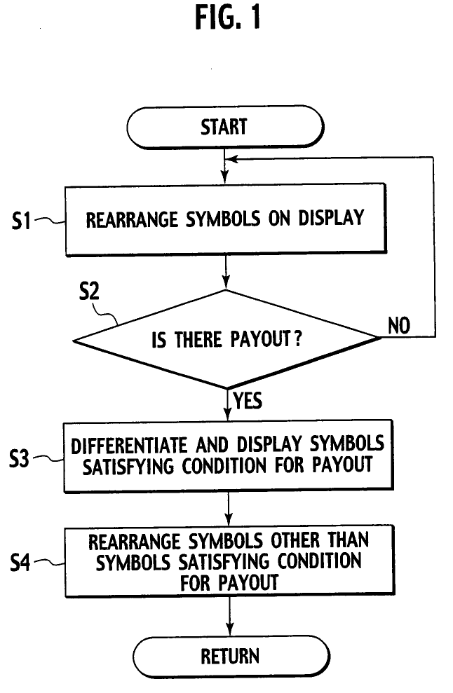

FIG. 1 is a flowchart schematically showing an operation of a slot machine according to an embodiment of the present invention. Hereinafter, the operation of the slot machine according to the embodiment is schematically described with reference to the flowchart shown in FIG. 1. The slot machine is a stand-alone slot machine which is not connected to a network, but the present invention can be applied to a slot machine connected to a network.

As shown in FIG. 1, the slot machine according to the embodiment rearranges symbols on a display in step S1. The slot machine proceeds to step S2 and determines based on the arrangement of the symbols rearranged in the step S1 whether to make a payout. For example, the payout is made when a same type of symbols are arranged.

A negative result obtained in the step S2 means that the payout is not made, and the slog machine returns to the step S1 and rearranges all the symbols arranged on the display.

On the other hand, a positive result obtained in the step S2 means that the payout is made, and the slot machine proceeds from the step S2 to step S3.

In the step S3, the slot machine differentiates display of symbols satisfying a condition for payout from display of the other symbols. The symbols satisfying the condition for payout means, for example, the same type of symbols among the rearranged symbols. Examples of the method of differentiating display of the symbols satisfying the condition for payout from display of the other symbols are a method of differentiating the display style of symbols themselves, such as setting brightness of the symbols satisfying the condition for payout higher than that of the other symbols, or a method of differentiating the display style of display regions, such as boxing each of regions where the symbols satisfying the condition for payout are displayed. The display style of symbols is a concept including color, shape, and size of symbols in addition to the brightness of symbols. Furthermore, the display style of symbols includes the location of symbols. Examples of the method of differentiating the locations where a symbol is displayed include a method of displaying a same symbol as the symbols satisfying the condition for payout outside of the region where symbols are rearranged and a like.

In subsequent step S4, the slot machine rearranges symbols other than the symbols satisfying the condition for payout. The symbols satisfying the condition for payout are therefore not rearranged and carried over to the next game.

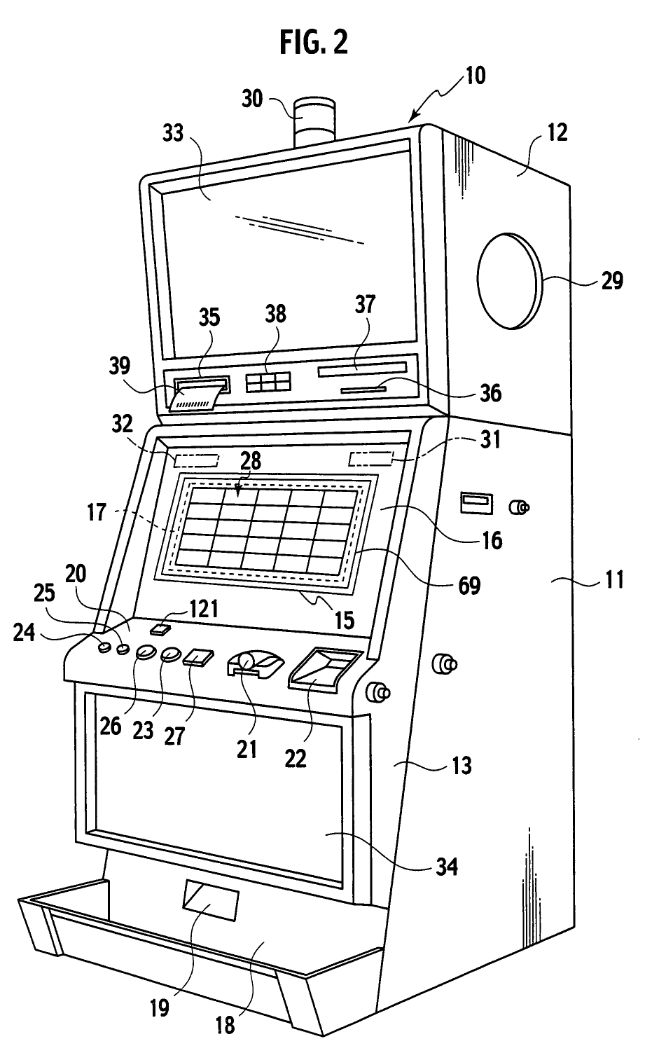

Next, the configuration of the slot machine 10 according to the embodiment of the present invention is described with reference to a perspective view shown in FIG. 2. The slot machine 10 is placed in gaming facilities.

In the slot machine 10, coins, bills, or bar-coded tickets 39 corresponding thereto are used as game media to execute a slot game. In the present invention, the game media are not particularly limited and may be, for example, medals, tokens, and electronic money.

As shown in FIG. 2, the slot machine 10 includes a cabinet (casing) 11, a top box 12, and a main door 13. The top box 12 is set above the cabinet 11. The main door 13 is provided in front of the cabinet 11.

The main door 13 is provided with a lower image display panel 16. The lower image display panel 16 includes a transparent liquid crystal panel, on which various types of information, effect images, and the like concerning games are displayed during gaming.

On the back side of the lower image display panel 16, a liquid crystal display unit 17 is provided. A display region 28 of the liquid crystal display unit 17 is visible from the front side of the lower image display panel 16 through a display window 15, which is formed in the lower image display panel 16. The display window 15 is a transparent region provided for a part of the lower image display panel 16.

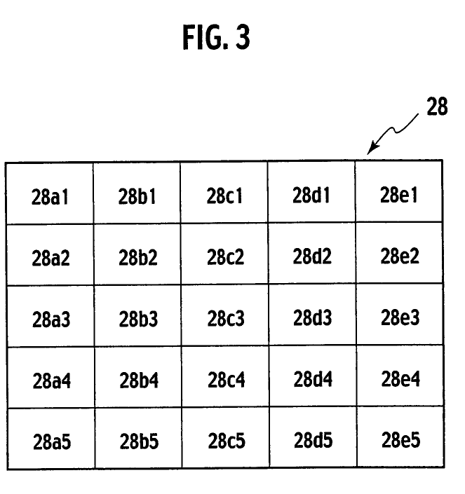

The display region 28 of the liquid crystal display unit 17 is divided into display regions 28a1 to 28e5 as shown in FIG. 3. When a gaming program is executed by a control circuit provided within the cabinet 11, the control circuit scrolls symbol rows each including a plurality of symbols at the individual display regions 28a1 to 28e5. Symbols displayed at each of the display regions 28a1 to 28e5 can therefore sequentially change.

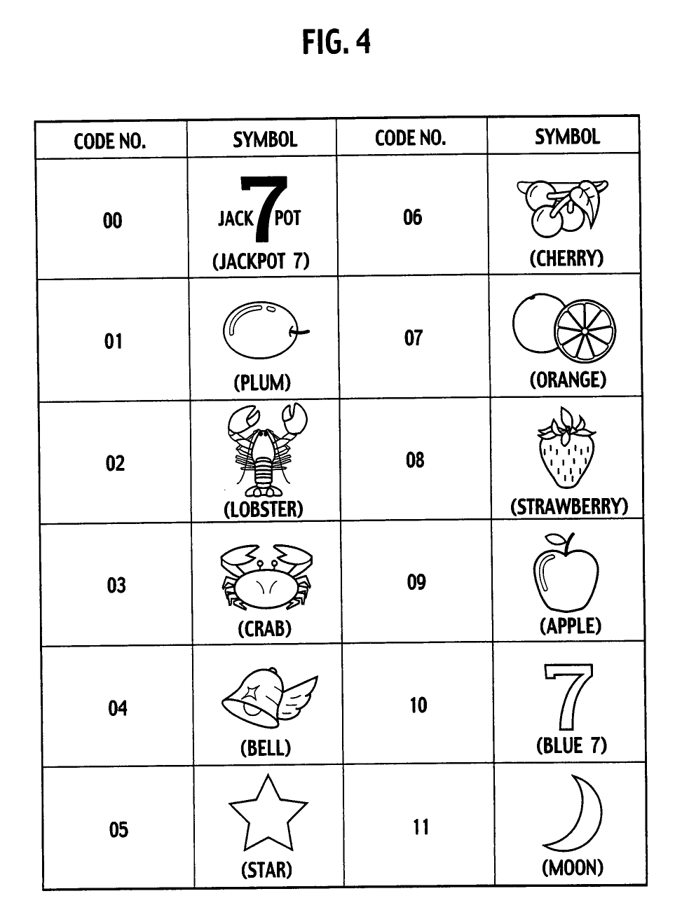

Each of the symbol rows is composed of a combination of symbols. The combinations of symbols constituting the individual symbol rows are different from each other. As shown in FIG. 4, each type of symbols is given a code number of 00 to 11. For example, symbols named “JACKPOT7” are given a code number “00”. Letters in blankets in FIG. 4 indicate names of the symbols.

After scrolling the symbol rows at the individual display regions 28a1 to 28e5, the control circuit executing the gaming program then stops scrolling the symbol rows. The symbols individually being scrolled and stopped at the display regions 28a1 to 28e5 are viewed from a player through the display window 15.

In this embodiment, the symbols are displayed using the liquid crystal display unit 17, but it is possible to prepare a plurality of mechanical reels and display symbols using the mechanical reels instead of the liquid crystal display unit 17.

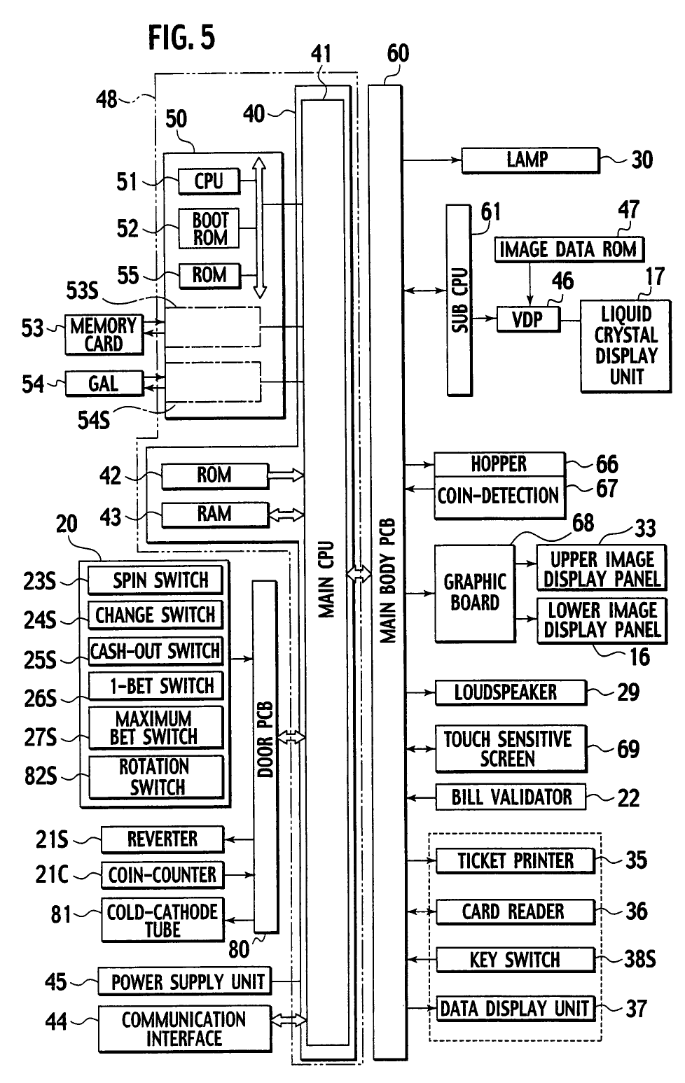

On the surface of the display window 15, a touch panel 69 is provided. The touch panel 69 is provided so as to face the entire display region 28. When a part of the touch panel 69 is pressed by the player, the touch panel 69 outputs a control input signal corresponding to the pressed part to a main CPU 41 (see FIG. 5) of the control circuit.

The lower image display panel 16 includes a credit amount display section 31 and a payout amount display section 32. In the credit amount display unit 31, the total number of coins which the slot machine 10 can pay out to the player (hereinafter, also referred to as a total number of credits) is displayed. The total number of credits is stored in a later-described RAM 43. In the payout amount display section 32, the number of coins paid out when a predetermined number of predetermined symbols stop in a base game or a hold game is displayed.

In lower part of the lower image display panel 16, a control panel 20 including a plurality of buttons (a spin button 23, a change button 24, a cash out button 25, a 1-BET button 26, a maximum BET button 27, and a cancel button 121), a coin insertion slot 21, a bill validator 22 are provided. The plurality of buttons 23 to 27 and 121 are operation buttons to input instructions concerning a game progress. The coin insertion slot 21 is an opening through which coins are inserted into the cabinet 11.

In the control panel 20, the spin button 23 is a button to input an instruction to start scrolling display of symbols. The change button 24 is a button used to request money changing for a clerk of the gaming facilities. The cash out button 25 is a button to input an instruction to pay out coins corresponding to the total number of credits to a coin tray 18.

The 1-BET button 26 is a button to input an instruction to bet one of coins corresponding to the total number of credits on a game. The maximum BET button 27 is a button to input an instruction to bet the maximum number of coins which can be bet on a game (for example, 50 coins) out of coins corresponding to the total number of credits.

The cancel button 121 is a button used to cancel a later-described transition to the hold game or to forcibly terminate the hold game during the hold game.

The bill validator 22 identifies whether inserted bills are normal and accepts only bills identified as normal bills into the cabinet 11. The bill validator 22 reads the bar-coded tickets 39 (described later) inserted. After reading the bar-code tickets 39, the bill validator 22 outputs a reading signal concerning the read contents to the main CPU 41 (described later) of the control circuit.

In lower front part of the main door 13 or in lower part of the control panel 20, a belly glass 34 is provided. On the belly glass 34, a character of the slot machine 10 and the like are drawn.

On the front of the top box 12, an upper image display panel 33 is provided. The upper image display panel 33 includes a liquid crystal panel, on which for example, effect images and images showing game introduction or rules are displayed.

In the top box 12, an audio output speaker 29 is provided. In lower part of the upper image display panel 33, a ticket printer 35, a card reader 36, a data display unit 37, and a keypad 38 are provided. The ticket printer 35 prints a bar code obtained by coding data on a ticket and outputs the ticket as the bar-coded ticket 39. The data of the printed bar-code includes the total number of credits, a number of jackpot credits, date and time, and an ID number of the slot machine 10.

The bar-coded tickets 39 are used in gaming at the slot machine and in changing the bar-coded tickets 39 into bills at a casher of the gaming facility and the like.

The card reader 36 reads data from a smart card and writes data in the smart card. The smart card is owned by the player and stores, for example, data identifying the player and data related to history of games played by the player into a memory provided within the smart card.

The data display unit 37 is composed of a fluorescent display and the like, which displays, for example, the data read by the card reader 36 and data inputted by the player with the keypad 38. The keypad 38 is to input data and instructions concerning ticket issue and the like.

FIG. 5 is a block diagram showing the control circuit of the slot machine 10 shown in FIG. 2. As shown in FIG. 5, the control circuit is composed of constituent elements including a motherboard 40, a body printed circuit board (PCB) 60, a sub-CPU 61, a gaming board 50, a door PCB 80, various switches, and sensors. The motherboard 40 and gaming board 50 constitute a controller 48.

The gaming board 50 includes a central processing unit (CPU) 51, a ROM 55, a boot ROM 52, a card slot 53S, which accepts a memory card 53, and an IC socket 54S, which accepts a generic array logic (GAL) 54. The CPU 51, ROM 55, boot ROM 52, card slot 53S, and IC socket 54S are connected to each other through an internal bus.

The memory card 53 stores a game program and a game system program. The game program includes a stop symbol determination program. The stop symbol determination program is a program to determine a symbol (a code number corresponding to the symbol) stopped at each of the display regions 28a1 to 28e5. The stop symbol determination program includes symbol weight data corresponding to several types of payout rates (for example, 80, 84, and 88%). The symbol weight data is data representing a corresponding relationship between the code number (see FIG. 4) of a symbol and one or more random numbers in a predetermined numerical range (0 to 255) for each of the display regions 28a1 to 28e5.

The payout rates are set based on payout rate setting data outputted from the GAL 54. The symbols and the like stopped at the individual display regions 28a1 to 28e5 are determined based on the symbol weight data corresponding to the payout rates.

The card slot 53S is configured so that the memory card 53 can be inserted into or removed from the card slot 53S and connected to the motherboard 40 through an IDE bus. The type and contents of a game performed at the slot machine 10 can be therefore changed by detaching the memory card 53 from the card slot 53S, writing another game program and another game system program in the memory card 53, and inserting the same into the card slot 53S.

The game program includes a program concerning the gaming progress. The game program includes image data and sound data outputted during gaming. The game program further includes image data and sound data as information data to inform the player when the hold game is determined to be executed that the touch panel 69 can be pressed and that the hold game begins.

The GAL 54 includes a plurality of input and output ports. When data is inputted to the input ports, data corresponding to the inputted data is outputted from the output ports. The data outputted from the output data is the aforementioned payout rate setting data.

The IC socket 54S is configured so that the GAL 54 can be attached to and detached from the IC socket 54S and is connected to the motherboard 40 through a PCI bus. The payout rate setting data outputted from the GAL 54 can be modified by detaching the GAL 54 from the IC socket 54S, rewriting the program stored in the GAL 54, and attaching the GAL 54 to the IC socket 54S.

The CPU 51, ROM 55, and boot ROM 52, which are connected to each other through the internal bus, are connected to the motherboard 40 through the PCI bus. The PCI bus transmits signals between the motherboard 40 and the gaming board 50 and supplies electric power from the motherboard 40 to the gaming board 50. The ROM 55 stores country identification information and an authentication program. The boot ROM 52 stores a backup authentication program, a program (boot codes) for the CPU 51 to start the backup authentication program, and the like.

The authentication program is a program (a falsification check program) to authenticate the game program and game system program. The authentication program is a program to confirm and verify that the game program and game system program are not altered. Specifically, the authentication program is described along a procedure to perform authentication of the game program and game system program. The backup authentication program is a program to authenticate the aforementioned authentication program. The backup authentication program is described along a procedure to verify that the authentication program as a target of authentication is not altered, or to authenticate the authentication program.

The motherboard 40 includes the main CPU 41, a read only memory (ROM) 42, a random access memory (RAM) 43, and a communication interface 44.

When some of coins corresponding to the total number of credits are bet and the spin button 23 is pressed, the main CPU 41 outputs a scroll instruction signal to the sub CPU 61 to cause the liquid crystal display unit 17 to scroll symbols. After the symbols begin scrolling, the main CPU 41 determines symbols to be stopped at the individual display regions 28a1 to 28e5 and outputs a stop instruction signal to the sub CPU 61 to stop the determined symbols at the individual display regions 28a1 to 28e5. The sub CPU 61 carries out various processes based on the signals received from the main CPU 41.

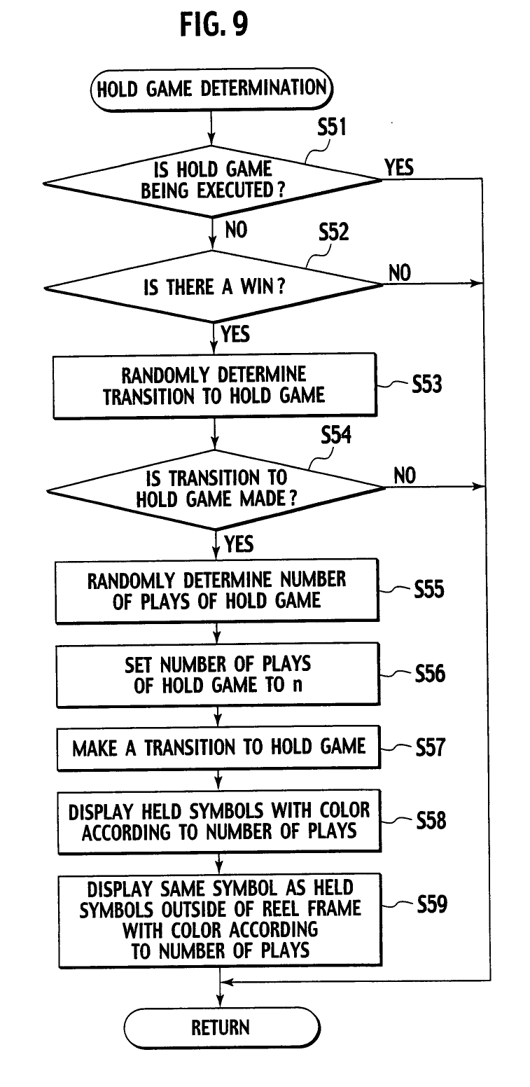

The main CPU 41 executes the hold game when a predetermined condition is satisfied in the later-described hold game determination process (FIG. 9). The details of the hold game are described later.

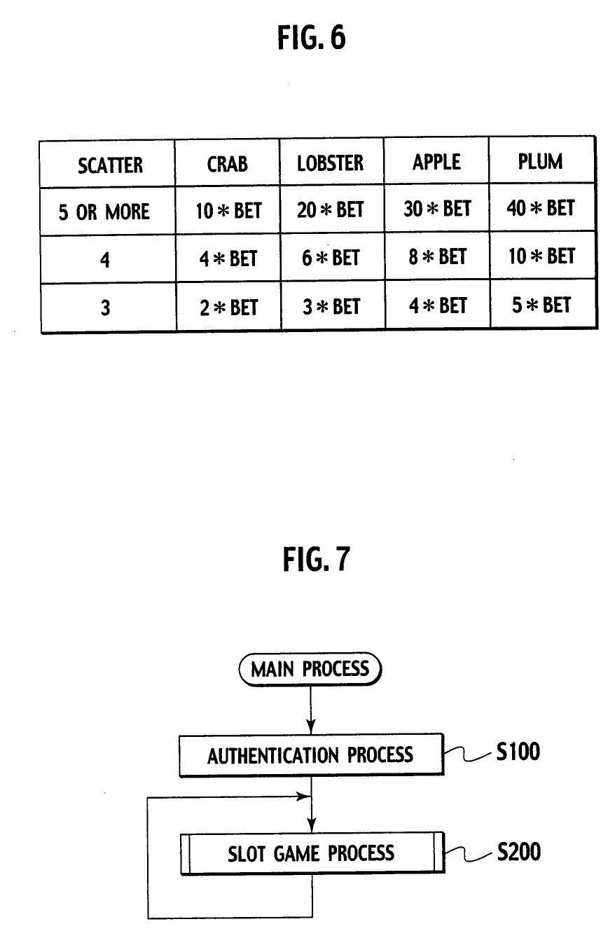

The ROM 42 stores programs such as a basic input/output system (BIOS) executed by the main CPU 41 and stores data permanently used. When the BIOS is executed by the main CPU 41, a process to initialize peripheral devices is performed, and a process to read the game program and game system program stored in the memory card 53 through the gaming board 50 is started. The ROM 42 stores the payout table shown in FIG. 6. The payout table shows a corresponding relationship between the condition to pay out coins and the number of coins paid out when the condition is satisfied. The condition to pay out coins is indicated by a type of symbols stopped at the display regions 28a1 to 28e5, or stop symbols, and the number of the stop symbols. In the slot game of this embodiment, the main CPU 41 determines based on the payout table shown in FIG. 6 and symbols stopped at the individual display regions 28a1 to 28e5 whether to pay out coins and the number of coins to be paid out. According to the payout table, for example, when five “PLUM” symbols or more are stopped in the display region 28, the number of coins to be paid out is forty times the number of bet coins. The number of bet coins is a number of coins bet on a unit game. As described above in the slot machine 10 of this embodiment, the payout amount is determined according to the type of symbols stopped in the display region 28 (28a1 to 28e5) and the number of stopped symbols without setting a payline.

The RAM 43 stores data and programs used when the main CPU 41 carries out processes. The RAM 43 includes an area storing the number n of plays of the hold game, an area storing the total number of credits, and the like.

The communication interface 44 allows the slot machine 10 to communicate with a host computer provided in the gaming facilities and the like through a communication line.

The motherboard 40 is connected to a later-described body printed circuit board (PCB) 60 and a door PCB 80 through universal serial buses (USBs). The mother board 40 is further connected to a power supply unit 45. When power is supplied from the power supply unit 45 to the motherboard 40, the main CPU 41 of the motherboard 40 is started. Simultaneously, power is supplied to the gaming board 50 through the PCI bus to start the CPU 51.

The body PCB 60 and door PCB 80 are connected to units and devices generating input signals inputted to the main CPU 41 and units and devices whose operations are controlled by control signals outputted from the main CPU 41. The main CPU 41 executes the game program and game system program stored in the RAM 43 based on the input signals inputted to the main CPU 41 to perform arithmetic processing and store the result thereof in the RAM 43 or perform a process to send the control signals to individual units and devices as the process to control the individual units and devices.

The body PCB 60 is connected to a lamp 30, the sub CPU 61, a hopper 66, a coin detector 67, a graphic board 68, the speaker 29, a touch panel 69, the bill validator 22, the ticket printer 35, the card reader 36, the key switch 38S, and the data display unit 37. The lamp 30 is controlled by the main CPU 41 to be turned on and off.

The sub CPU 61 scrolls and stops symbols at the individual display regions 28a1 to 28e5, which are set in the liquid crystal display unit 17, based on the control signals from the main CPU 41 and is connected to a video display processor (VDP) 46. Moreover, the sub CPU 61 individually controls color and brightness of the display regions 28a1 to 28e5, which are set in the liquid crystal display unit 17, based on the control signal from the main CPU 41.

The VDP 46 reads image data of symbols stored in an image data ROM 47, creates a scroll image to be displayed in the liquid crystal display unit 17, and then outputs the scroll image to the liquid crystal display unit 17.

The hopper 66 is placed within the cabinet 11 and pays out a predetermined number of coins through a coin payout opening 19 to a coin tray 18 based on the control signals outputted from the main CPU 41. The coin detector 67 is provided within the coin payout opening 19 and outputs the input signal to the main CPU 41 upon detecting that the predetermined number of coins have been paid out through the coin payout opening 19.

The graphic board 68 controls image display in the upper and lower image display panels 33 and 16 based on the control signal outputted from the main CPU 41. In the credit amount display section 31 of the lower image display panel 16, the total number of credits stored in the RAM 43 is displayed. In the payout amount display section 32 of the lower image display panel 16, the number of coins paid out is displayed. The graphic board 68 includes a video display processor (VDP) which creates image data based on the control signal outputted from the main CPU 41 and a video RAM temporarily storing the image data created by the VDP.

The bill validator 22 reads images of bills and accepts a normal bill into the cabinet 11. When accepting the normal bill, the bill validator 22 outputs the input signal to the main CPU 41 based on the amount of the bill. The main CPU 41 adds the number of credits corresponding to the amount of the bill transmitted by the input signal to the total number of credits.

The ticket printer 35 prints a bar code which is obtained by coding data on a ticket and outputs the ticket as the bar-coded ticket 39. The date of the printed bar code includes the total number of credits, the number of jackpot credits, date and time, and the ID number of the slot machine 10.

The card reader 36 reads data from a smart card and sends the read data to the main CPU 41 or writes data in the smart card based on a control signal from the main CPU 41. The key switch 38S is provided for the keypad 38 and outputs the input signal to the main CPU 41 when the keypad 38 is operated by the player.

The data display unit 37 displays the data read by the card reader 36 and data inputted by the player through the keypad 38 based on the control signal outputted from the main CPU 41.

The door PCB 80 is connected to the control panel 20, a reverter 21S, the coin counter 21C, and a cold-cathode tube 81. The control panel 20 includes a spin switch 23S corresponding to the spin button 23, a change switch 24S corresponding to the change button 24, a cash out switch 25S corresponding to the cash out button 25, a 1-BET switch 26S corresponding to the 1-BET button 26, and a maximum BET switch 27S corresponding to the maximum BET switch 27. The switches 23S to 27S individually output input signals to the main CPU 41 when the respective buttons 23 to 27 are operated by the player.

The coin counter 21C is provided within the coin insertion slot 21 and identifies whether each coin inserted into the coin insertion slot 21 by the player is normal. Coins other than normal coins are discharged from the coin payout opening 19. The coin counter 21C outputs the input signal to the main CPU 41 upon detecting a normal coin.

The reverter 21S operates based on the control signal outputted from the main CPU 41 and sorts the coins identified as normal coins by the coin counter 21C into a cash box (not shown) placed within the slot machine 10 or the hopper 66. In other words, when the hopper 66 is filled with coins, normal coins are sorted into the cash box by the reverter 21S. On the other hand, the hopper 66 is not filled with coins, normal coins are sorted into the hopper 66.

The cold cathode-tube 81 functions as a back light placed on the back sides of the lower and upper image display panels 16 and 33 and is lit based on the control signal outputted from the main CPU 41.

Next, a description is given of specific processes carried out in the slot machine 10. In the slot machine 10, the main CPU 41 carries out a main process shown in FIG. 7. Specifically, in step S100, the main CPU 41 performs the authentication process by the aforementioned authentication program. After finishing the authentication process, the main CPU 41 proceeds to step S200 and executes the slot game process.

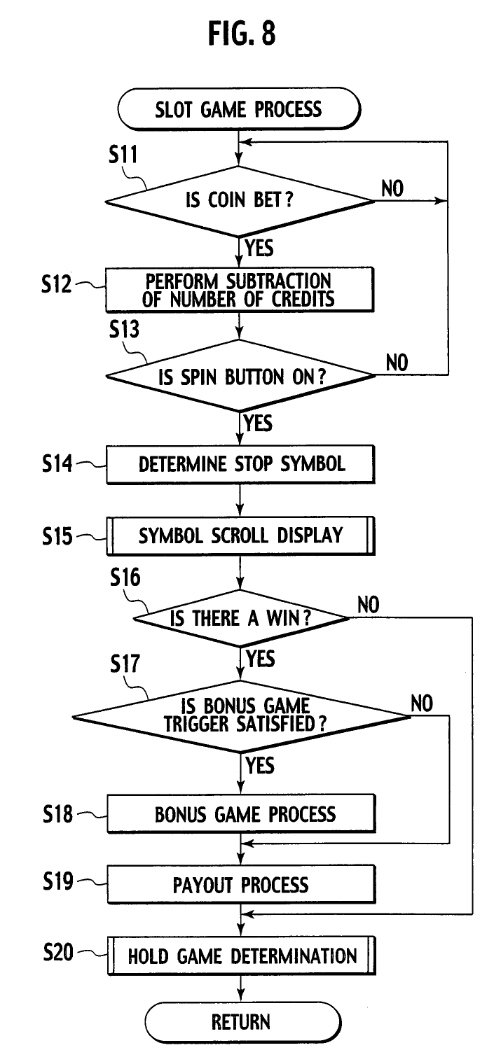

FIG. 8 is a flowchart showing a processing procedure of the slot game process executed by the main CPU 41 in the step S200 shown in FIG. 7. This process is a process in which the main CPU 41 executes a slot game program stored in the ROM 42.

Starting the slot game process shown in FIG. 8, the main CPU 41 determines in step S11 whether a coin is bet. In this process, the main CPU 41 determines whether the main CPU 41 has received the input signal outputted from the 1-BET switch 27S when the 1-BET button 27 is pressed or the input signal outputted from the maximum BET switch 27S when the maximum BET button 27 is pressed. When judging that a coin is not bet, the main CPU 41 returns the process to the step S11.

On the other hand, when judging that a coin is bet, the main CPU 41 proceeds to step S12 and subtracts the number of credits stored in the RAM 43 according to the number of coins bet.

Next, in step S13, the main CPU 41 determines whether the spin button 23 is turned on. In this process, the main CPU 41 determines whether the main CPU 41 has received the input signal outputted from the spin switch 23S when the spin button 23 is turned on.

When determining that the spin button 23 is not turned on, the main CPU 41 returns the process to the step S11. When the spin button 23 is not turned on (for example, a case where an instruction to terminate the game is inputted before the spin button 23 is turned on), the main CPU 41 cancels the result of the subtraction of the number of credits in the step S12.

When determining in the step S13 that the spin button 23 is turned on, the main CPU 41 proceeds from the step S13 to step S14 and determines the stop symbols. In this stop symbol determination process, the main CPU 41 executes a stop symbol determination program stored in the RAM 43 to determine symbols to be displayed through the display window 15 when the symbols are stopped in the individual display regions 28a1 to 28e5. In this process, the main CPU 41 executes a random number generation program to select a corresponding random number from numerals of 0 to 255 for each of the display regions 28a1 to 28e5. With reference to the symbol weight data according to the payout rate setting data, the main CPU 41 determines the code number (FIG. 4) of the symbol to be stopped at each of the display regions 28a1 to 28e5 based on the selected random number.

Next, the main CPU 41 carries out the symbol scroll display process in step S15. This process is a process to start and then stop scrolling the symbols at the display regions 28a1 to 28e5. With this process to start and stop scrolling, symbols are rearranged at the individual display regions 28a1 to 28e5. This scroll display process is described later.

When the scroll display process is finished, the main CPU 41 proceeds to step S16 and determines based on the stopped symbols whether there is a win. Specifically, the main CPU 41 determines whether the condition for payout is satisfied. In this step S16, the main CPU 41 determines which combination of the type and number set in the payout table matches the combination of the number of same symbols among the symbols stopped in the aforementioned step S15 and the type of the same symbols. When there is a combination matching any one of the combinations set in the payout table, the main CPU 41 recognizes that there is a win and determines the number of paid out coins which is set according to the type and the number of symbols. The main CPU 41 proceeds from the step S16 to step S17. In this case, among the rearranged symbols, the same type of symbols whose combination of the number and type matches the combination of the type and number set in the payout table are symbols satisfying the condition for payout. On the other hand, when there is no combination matching any combination of the type and number set in the payout table among the symbols stopped in the aforementioned step S15, the main CPU 41 determines that there is no win and proceeds from the step S16 to step S20.

In the step S17, the main CPU 41 determines whether a bonus trigger is satisfied. In this embodiment, a predetermined combination of symbols is stored in the ROM 42 in advance as a condition to satisfy the bonus trigger. The main CPU 41 determines whether this predetermined combination is included in the symbols stopped in the aforementioned step S15. When the predetermined combination is included, the main CPU 41 determines that the bonus trigger is satisfied and proceeds from the step S17 to step S18 to execute a bonus game process. The bonus game is a game in which, for example, a predetermined number of plays advantageous for the player continue. On the other hand, when the combination as the condition to satisfy the bonus trigger is not included in the symbols stopped in the aforementioned step S15, the main CPU 41 proceeds from step S17 to the step S19.

In the step S19, the main PCU 41 executes a process to pay out coins according to the winning result in the step S16 and the result of the bonus game in the step S18. In this payout process, the main CPU 41 adds the number of credits generated in the step S16 and the number of credits generated in the bonus game to the number of credits stored in the RAM 43.

After the payout process is finished, the main CPU 41 proceeds to step S20 and executes the hold game determination process. This process is a process to determine whether to execute the hold game as a special game. When it is determined in the hold game determination process to make a transition to the hold game, the hold game is executed at the subsequent plays until the condition to terminate the hold games is established. The hold game is a game in which symbols other than the symbols satisfying the condition for payout among the rearranged symbols are rearranged at the next play to carry over the symbols satisfying the condition for payout to the next play. Herein, to carry over symbols to the next play without rearranging the same is referred to as “to hold”. The hold game determination process is described later.

In the slot machine 10, the slot game process shown in FIG. 8 is executed to start the slot game when the coins are bet and the spin button is turned on. The stop symbols are then determined, and symbols are scrolled so that the determined stop symbols stop at the display regions 28a1 to 28e5.

It is then determined according to the symbols stopped at the individual display regions 28a1 to 28e5 whether there is a win. When there is a win, payout of coins according to the content of the win is performed. For each play, the hold game determination process to determine whether to execute the hold game is executed. When it is determined to make a transition to the hold game, the hold game is executed from the next play. While the hold game is being executed, payout of coins is performed according to the winning result of each play of the hold game in the step S19.

Next, the hold game determination process (step S20) in the slot game process of FIG. 8 is described in detail.

FIG. 9 is a flowchart showing a procedure of the hold game determination process executed in the step S20 of FIG. 8. Starting the hold game determination process, the main CPU 41 determines in step S51 whether the hold game is being executed. A positive result obtained herein means that a transition is already made to the hold game at a previous play or before and the hold game is currently being executed. The main CPU 41 then returns from the step S51 to the slot game process (see FIG. 8) as the main routine. On the other hand, a negative result in the step S51 means that the hold game is not being executed, and the main CPU 41 proceeds from the step S51 to step S52.

In the step S52, the main CPU 41 determines whether there is a win. A negative result herein means that there is no win, and the main CPU 41 returns from the step S52 to the slot game process (FIG. 8) as the main routine. On the other hand, a positive result obtained in the step S52 means that there is a win, and the main CPU 41 proceeds from the step S52 to step S53.

In the step S53, the main CPU 41 randomly determines a transition to the hold game. Specifically, the main CPU 41 executes a program for generating a random number to select on of ransom numbers from 0 to 255 and then determines based on the selected random number whether to make a transition to the hold state at the next play of the slot game. A table representing a relation between the random number and whether to make a transition is previously stored in the ROM 42. Whether to make a transition to the hold game determined in the step S53 is stored in the RAM 43.

In the case of making a transition to the hold game according to the result of the determination, the main CPU 41 proceeds from the step S53 to step S55.

In the step S55, the main CPU 41 randomly determines the number of plays of the hold game. In this case, the main CPU 41 selects one of random numbers from 0 to 255 and then determines the number of plays corresponding to the selected random number. A table representing the relation between the random number and the number of plays is stored in advance. The number of plays means the number of times that the hold game is repeated after the current point of time.

The main CPU 41 then proceeds to step S56 and sets the number of plays which is determined in the step S55 to n. The main CPU 41 stores the value of n in the RAM 43.

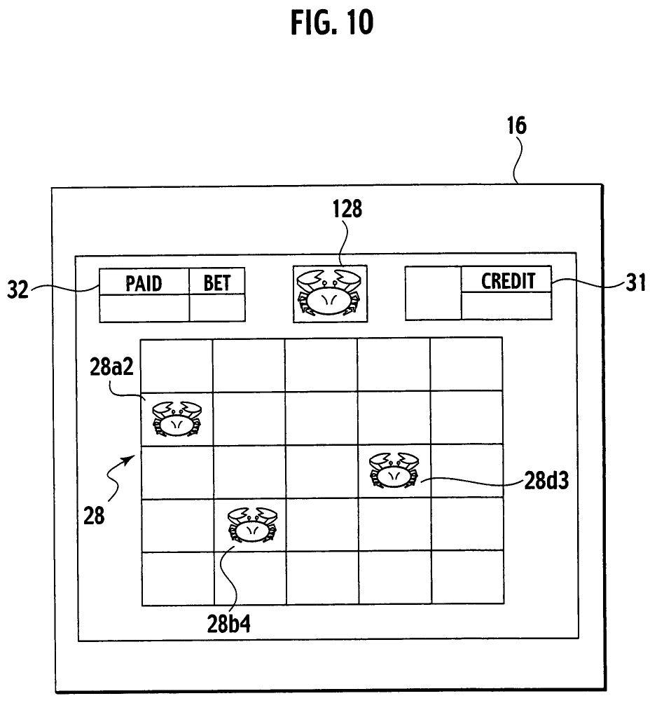

The main CPU 41 proceeds to step S57 and makes a transition to the hold game. In this processing step, the main CPU 41 changes a hold game execution flag held in the RAM 43 from 0 to 1. While the hold game execution flag is 1, the main CPU 41 executes the hold game. The main CPU 41 further holds symbols which establish a win. For example, as shown in FIG. 10, when “CRAB” symbols stop at the three display regions 28a2, 28b4, and 28d3 among the display regions 28a1 to 28e5 to establish a win, the main CPU 41 holds these three symbols. These three symbols are not scrolled and remain stopped in the next play. In FIG. 10, only the held symbols are displayed among the symbols displayed at the individual display regions 28a1 to 28e5.

While the hold game is being executed, payout of coins is not performed by the combination of only the held symbols. When a same symbol as the held symbols is additionally stopped, a payout of coins is performed based on the payout table shown in FIG. 6. For example, as shown in FIG. 10, when the three “CRAB” symbols are held, the payout of coins by this combination of these three symbols is not carried out at the next play, and when a same “CRAB” symbol stops at another display region in addition to the three “CRAB” symbols, payout of coins is carried out according to the total number of the stopped symbol and the three held symbols. Such determination is performed by the main CPU 41 in the payout process (step S19) shown in FIG. 8.

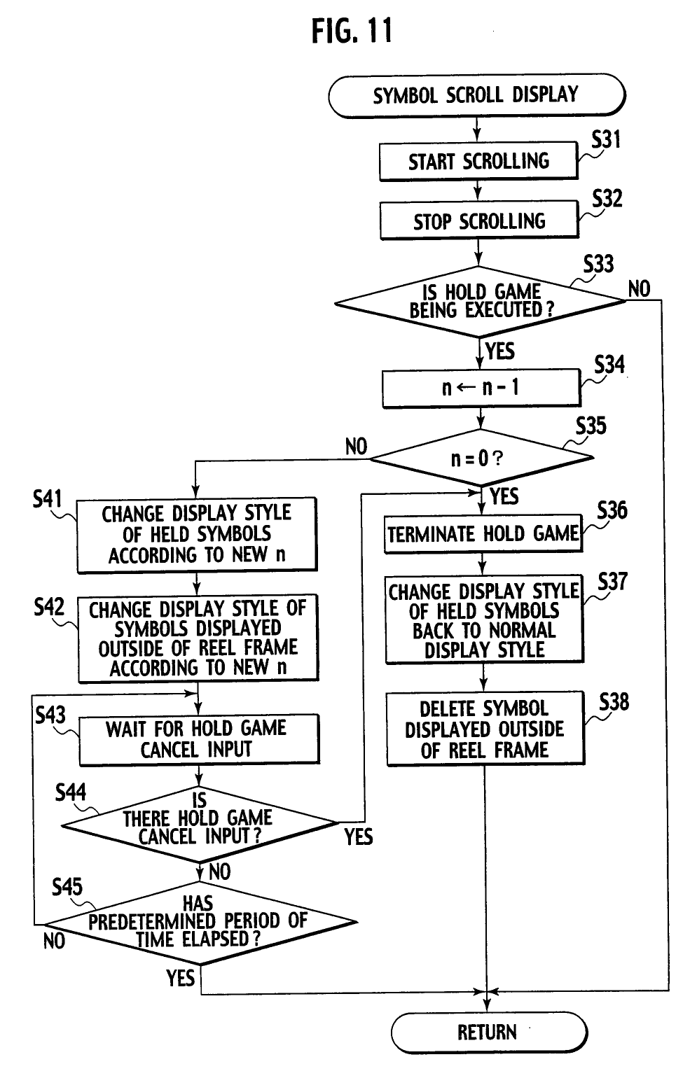

Subsequently, the main CPU 41 proceeds to step S58 and displays the held symbols with color according to the number of plays which is determined in the step S55. The table representing the relation between the number of plays and color of symbols is stored in the ROM 42 in advance, and the main CPU 41 selects a color from the table according to the number of plays based on a value set as the number n of plays in the step S56. The main CPU 41 displays the held symbols with the selected color. The color is different from color of the other symbols not held. Furthermore, when displaying the held symbols with the color according to the number of plays, the main CPU 41 sets brightness of the display regions thereof higher than that of the display regions where the other symbols not held are displayed. Examples of the way of setting higher brightness include a way of increasing light transmission at the corresponding display regions to increase the amount of transmitted light from the backlight or the like. Moreover, instead of setting higher brightness at the corresponding display regions, the brightness of the other display regions may be set lower. The held symbols thus displayed with a different display style (color and brightness) from the display style of the other symbols. The held symbols are therefore highlighted. In this embodiment, as described later in FIG. 11, after the number n of plays is set in the steps S55 and S56, the number n of plays is decremented by one each time that the hold game is repeated. The color of the held symbols is controlled so as to change according to the result of decrement (the number of remaining plays). For example, when the number of remaining plays is 10 or more, blue is set in the table; 5 to 9, yellow; and 1 to 4, red. Moreover, a way of controlling the display is set in the table so that the red display blinks when the number of remaining plays is 1 or more and less than 3. The main CPU 41 reads out the color and brightness according to the number n of remaining plays from the table and makes a control so that the held symbols are displayed with the color and brightness read out. Moreover, the main CPU 41 causes symbols to blink based on information indicating “blinking” set in the table when the number n of remaining plays is 1 or more and less than 3.

As described above, the main CPU 41 highlights the held symbols among the symbols displayed at the display regions 28a1 to 28e5 and changes the display of the held symbols according to the number of plays to be executed in the hold game.

The main CPU 41 proceeds to subsequent step S59 and displays a same symbol as the held symbols outside of the reel frame with color according to the number n of plays. Herein, the reel frame means a frame of the entire display region of the display regions 28a1 to 28e5 as a first display region. Accordingly, the outside of the reel frame means a second display region (region 128) outside of the display region 28 (28a1 to 28e5) In this embodiment, as shown in FIG. 10, the same symbol as the held symbols is displayed in the region 128 as the second display region, which is other than the display region 28 as the first display region. In FIG. 10, the “CRAB” symbols are held, and a “CRAB” symbol is displayed in the region 128. The not-blinking symbol displayed in the region 128 may be also changed so as to blink according to the number n of remaining plays. Moreover, when several types of symbols are held as a result of establishment of wins, the main CPU 41 highlights all the types of symbols held in the display region 28 and displays same symbols as the several types of symbols held outside of the reel frame.

After the hold game determination process is executed as described above, the main CPU 41 returns to the slot game process shown in FIG. 8.

Next, a description is given of the symbol scroll display process (step S15) in the slot game process in detail.

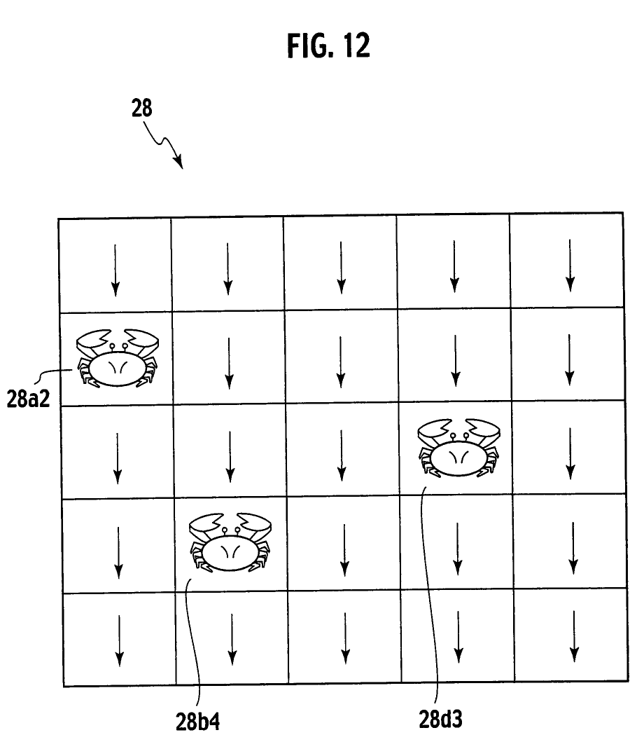

FIG. 11 is a flowchart showing a procedure of the symbol scroll display process executed in the step S15 of FIG. 8. Starting the symbol scroll display process, the main CPU 41 begins scrolling symbols at the display regions 28a1 to 28e5 in step S31. In this process, when the transition to the hold game is already made by the aforementioned hold game determination process, the main CPU 41 scrolls symbols at the display regions other than the display regions where the symbols are held, and when the transition to the hold game is not made, the main CPU 41 scrolls symbols at all the display regions 28a1 to 28e5. For example, when “CRAB” symbols at the three display regions 28a2, 28b4, and 28d3 are held among the display regions 28a1 to 28e5 as shown in FIG. 10, the main CPU 41 continues holding the symbols at these three display regions 28a2, 28b4, and 28d3 while scrolling the symbols at the other display regions. In FIG. 12, down arrows indicate that the symbols are scrolling.

The main CPU 41 proceeds to step S32 and makes a control so that symbols determined in the step S14 (FIG. 8) stop at the display regions 28a1 to 28e5 where the symbols are scrolling.

When the symbols in the display region stop scrolling, the main CPU 41 proceeds to step S33 and determines whether the hold game is being executed. In this determination, the main CPU 41 determines whether the hold game is being executed with reference to the hold game execution flag set in the RAM 43. A negative result herein means that the transition to the hold game is not made in the hold game determination process (step S20) shown in FIG. 8, and the main CPU 41 returns from the step S33 to the slot game process shown in FIG. 8. On the other hand, a positive result obtained in the step S33 means that the hold game is being executed, and the main CPU 41 proceeds from the step S33 to step S34.

In the step S34, the main CPU 41 sets the number of plays of the hold game to n-1 to decrement the value of n by 1. In step S35, the main CPU determines whether n=0. A negative result herein means that the hold game will be continued, and the main CPU 41 proceeds from the step S35 to step S41. The main CPU 41 changes the display style of the held symbols according to the new value of the number n of plays. For example, when the number n of plays is changed from 5 to 4, the main CPU 41 changes the color of the symbols held in the display region 28 from blue to yellow. For example, when the number n of plays is changed from 3 to 2, the main CPU 41 changes the color of the held symbols and changes the display manner from unblinking to blinking.

The main CPU 41 proceeds to next step S42 and changes the display style of the symbol displayed in the region 128 (FIG. 10) outside of the reel frame according to the new value of the number n of plays. For example, when the number n of plays to be executed is changed from 5 to 4, the main CPU 41 changes the color of the symbol displayed in the display region 128 outside of the reel frame from blue to yellow. For example, when the number n of plays to be executed is changed from 3 to 2, the main CPU 41 changes the color of the symbol displayed in the region 128 as well as changes the display way from unblinking to blinking.

Such a change in the display style of the held symbols with a decrease in the number n of plays in the steps S41 and S42 changes the intensity of display of the held symbols, thus visually telling the number of remaining plays of the hold game to the player. Telling the number of remaining plays to the player with color and the like further enhances the entertainment experience in the slot game compared to the case of telling the number of remaining plays to the player with a clear indication such as numerals.

After the processes in the steps S41 and S42 are finished, the main CPU 41 proceeds to step S43 and waits for an input to cancel the hold game. This slot machine 10, as previously described in the explanation of FIG. 2, includes the cancel button 121 to cancel the hold game. When the cancel button 121 is operated during the hold game or the transition to the hold game, the main CPU 41 terminates the hold game.

After coming into the state of waiting for the input to cancel the hold game in the step S43, the main CPU 41 proceeds to step S44 and determines whether there is an input to cancel the hold game. A negative result herein means that the player has not operated the cancel button 121, and the main CPU 41 proceeds from the step S44 to step S45. The main CPU 41 then determines whether a predetermined time has elapsed. In this embodiment, when coming into the state of waiting for the input to cancel the hold game in the step S43, the main CPU 41 starts an internal timer and determines based on the count result of the internal timer whether the predetermined time has elapsed. When the predetermined time has not elapsed yet, the main CPU 41 obtains the negative result in the step S45, returns to the step S43, and repeats the processes in the steps S43, S44, and S45. On the other hand, when the predetermined time has elapsed, the main CPU 41 obtains the positive result in the step S45 and returns to the slot game process (FIG. 8) from the step S45.

On the other hand, a positive result obtained in the step S44 means that the player operates the cancel button 121 during the predetermined period of time when the input to cancel the hold game is waited for. The main CPU 41 proceeds from the step S44 to the step S36 and terminates the hold game. This embodiment is provided with means for forcibly terminating the hold game by an operation of the cancel button 121. Accordingly, for example, when the combination of symbols held in the hold game is not expected to lead to a large number of coins to be paid out, the player can be given an option to terminate the hold game on the player's own will and wait for next establishment of the hold game. This provides the player with a pleasure of predicting whether he/she can get a large amount of coins and making a choice by himself/herself.

When the hold game is forcibly terminated by the player operating the cancel button 121 or when the number of remaining plays of the hold game becomes zero, the main CPU 41 proceeds to the step S36 and terminates the hold game. In such a termination process, the main CPU 41 releases the holding of the held symbols to execute scrolling of symbols at all the display regions 28a1 to 28e5 at the next play.

The main CPU 41 then proceeds to step S37 and changes the display of the held symbols back to the normal display style. The normal display style means the display style of symbols not held. In the step S37, specifically, the main CPU 41 changes the color of the held symbols back to the color of the symbols not held and also changes the brightness of the held symbols back to the brightness of the symbols not held.

Subsequently, the main CPU 41 proceeds to step S38, deletes the symbol displayed in the region 128 outside of the reel frame, and then returns to the slot game process shown in FIG. 8.

Accordingly, while the hold game is being executed, symbols are not scrolled and fixed at some of the display regions 28a1 to 28e where the symbols are held, and the display style of the held symbols changes according to the number of remaining plays of the hold game. Moreover, while the hold game is being executed, a same symbol as the held symbols is displayed in the region 128 outside of the reel frame, and the display style of the same changes according to the number of remaining plays of the hold game.

In the slot machine 10, with the slot game described above, the held symbols are highlighted and displayed during the hold game.

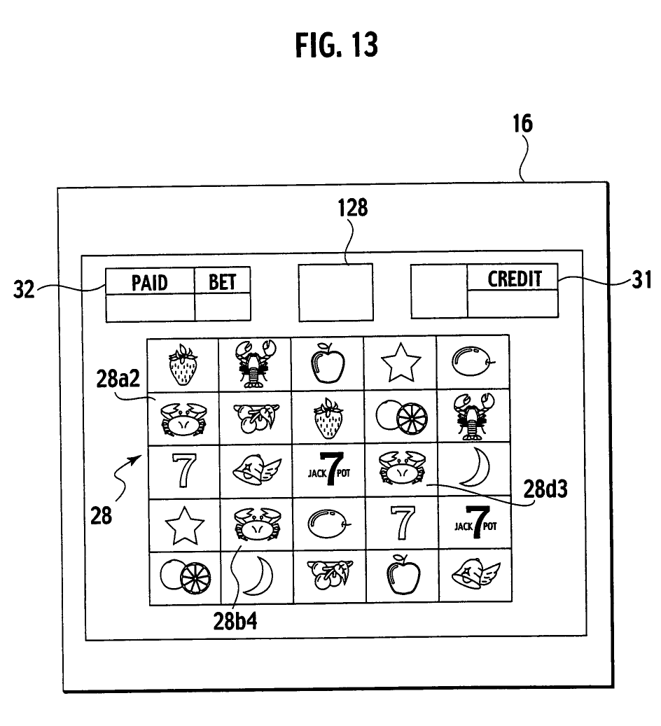

For example, as shown in FIG. 13, when symbols scroll and stop at all the display regions 28a1 to 28e5 in a state where the hold game is not being executed, “CRAB” symbols stopped at the three display regions 28a2, 28b4, and 28d3 establish a win according to the payout table shown in FIG. 6. Based on this result, the main CPU 41 randomly determines whether to make a transition to the hold game. When the main CPU 41 determines to make a transition to the hold game, the “CRAB” symbols are held at the three display regions 28a2, 28b4, and 28d3. At this time, the number n of plays of the hold game is randomly determined.

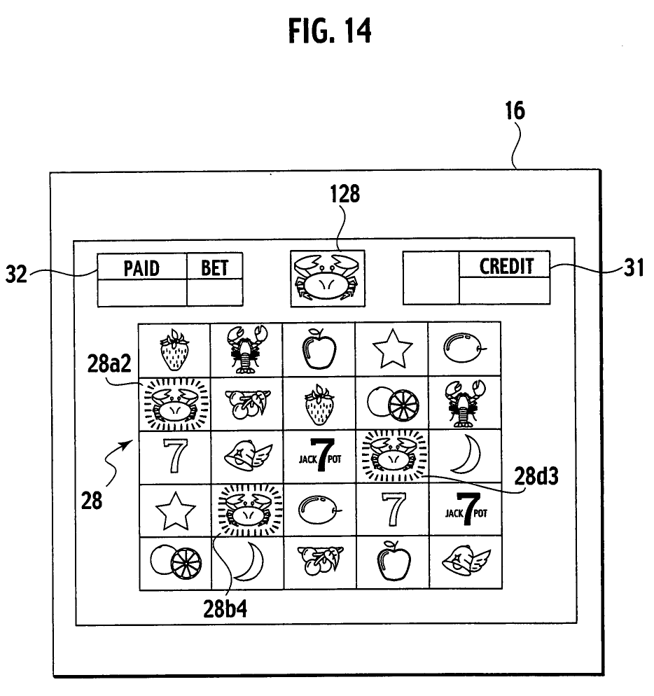

As shown in FIG. 14, the held symbols are displayed with higher brightness than that of the other display regions and with color according to the number n of plays of the hold game which is randomly determined. Moreover, in the region 128 outside of the reel frame, a same symbol as the held symbols is displayed with a color according to the number n of plays of the hold game.

In the slot game in which the transition to the hold game is randomly determined, the transition to the hold game and the held symbols are visually transmitted to the player by the change in brightness of the held symbols. In this case, the brightness of the held symbols is different from that of symbols not held, so that the held symbols can be transmitted to the player so as to be distinguishable from the symbols not held. Moreover, in the slot game in which the number of plays of the hold game is randomly determined, the set number n of plays is visually transmitted to the player by the color of the held symbols. Furthermore, the change in the number n of plays of the hold game is visually transmitted to the player by the change in color of the held symbols.

As described above, the held symbols can be visually transmitted to the player, and the player is given an opportunity to select whether to cancel the hold game. Specifically, the player can be given an opportunity to decide based on the held symbols whether to continue the hold game.

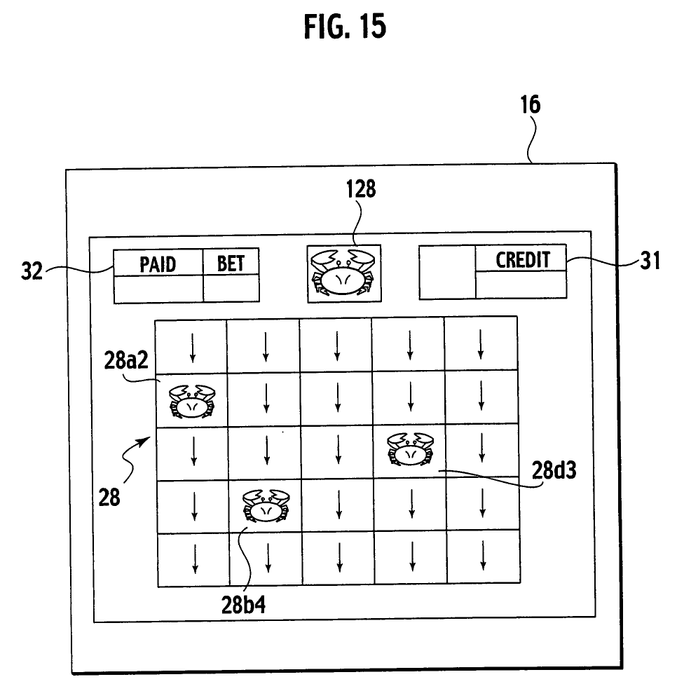

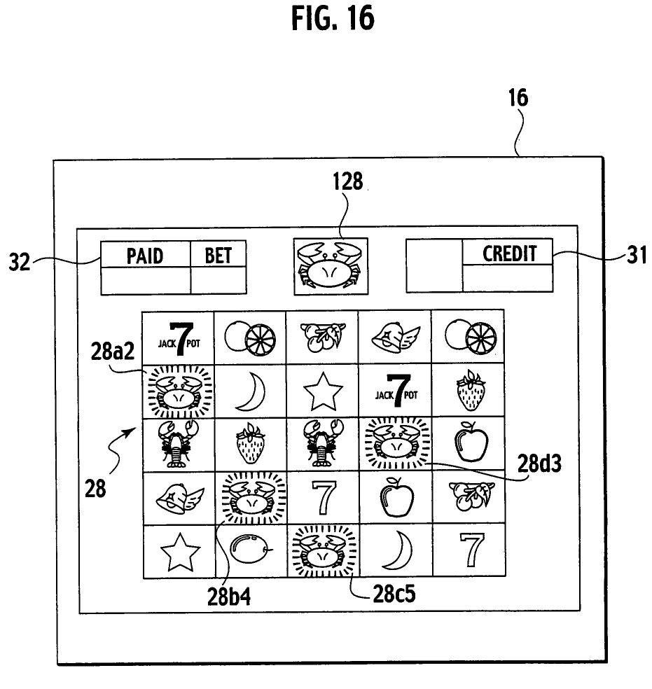

When the player selects to continue the hold game, as shown in FIG. 15, symbols displayed in the display regions other than the display regions 28a2, 28b4, and 28d3 of the held symbols begin scrolling and then stop.

As shown in FIG. 16, when the stopped symbols include same symbols as the held symbols (for example, “CRAB”), the number of held symbols (for example, three) is added to the number of same symbols stopped (for example, one), and a payout corresponding to the result of addition (for example, four) is given to the player. In this case, the payout is previously determined for each type of symbols according to the payout table shown in FIG. 6. Accordingly, depending on the type of held symbols, there is a possibility to get a large payout at the next play. Based on this term as information for making a decision, the player decides whether to cancel the hold game. The opportunity for the player to make a decision based on such information for making a decision can further enhance the amusement of the slot game.

In the aforementioned embodiment, the description is given of the case where a predetermined number of symbols of one type (for example, symbols “CRAB”) stop in the display region 28 to establish a win. In the case where several combinations each including the same type of symbols stop in the display region 28 to establish a plurality of wins, the symbols establishing the individual wins are displayed brighter than the other symbols. In this case, the main CPU 41 displays symbols of each win with different colors to differentiate the symbols of each established win from the symbols of the other wins. Moreover, in this case, a plurality of symbols are displayed in the region 128 according to the plurality of wins. The types of symbols establishing the wins can be thus clearly transmitted to the player.

Moreover, in the aforementioned embodiment, the description is given of the case where the player can be given the opportunity to decide whether to cancel the hold game after the transition to the hold game is determined in the step S57 (FIG. 9) and then the hold game is executed once. However, the present invention is not limited to this and may be configured to give the player the opportunity to cancel the hold game before the hold game is started after the transition to the hold game is determined. In this case, immediately after the transition to the hold game is determined in the hold game determination process (FIG. 8) of the step S20, the color and brightness of the held symbols are changed to highlight the same while the same symbol as the held symbols is displayed in the region 128 outside of the reel frame. The transition to the hold game and the held symbols are thus transmitted to the player. The player is then given the opportunity to cancel the hold game. Accordingly, the player is given the opportunity to decide whether to cancel the hold game before the hold game is actually started.

In the aforementioned embodiment, the display region 28 does not include a payline, and a win is established when a plurality of same symbols stop in the display region. Whether to make a transition to the hold game is randomly determined subject to such establishment of a win. However, the present invention is not limited to this and may be configured to determine the transition to the hold game as follows: For example, a payline is provided, and a win is established when a plurality of predetermined symbols stop on the payline. The transition to the hold game is determined when such a win is established.

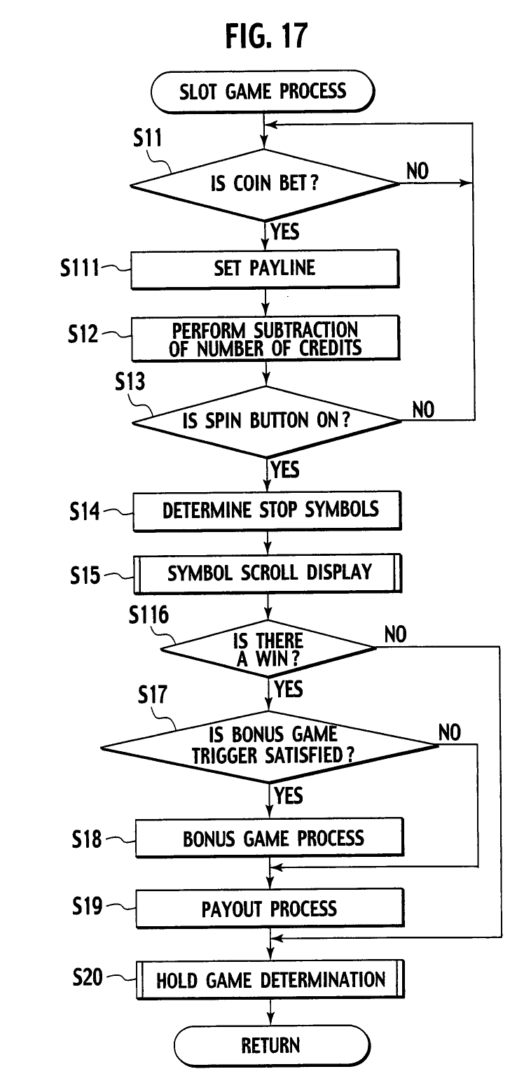

Hereinafter, a description is given of a slot game with a payline. FIG. 17 shows a processing procedure of the slot game with a payline. In FIG. 17, portions corresponding to those of FIG. 8 are given the same reference numerals, and redundant description is omitted.

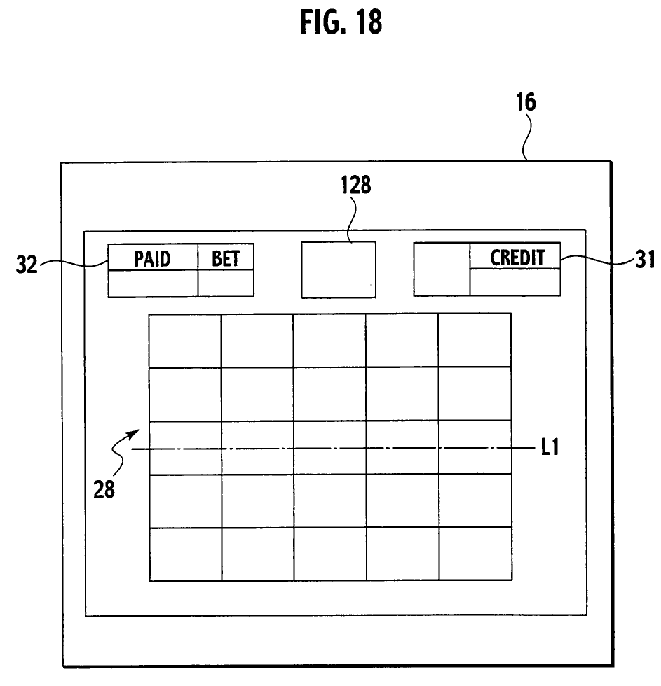

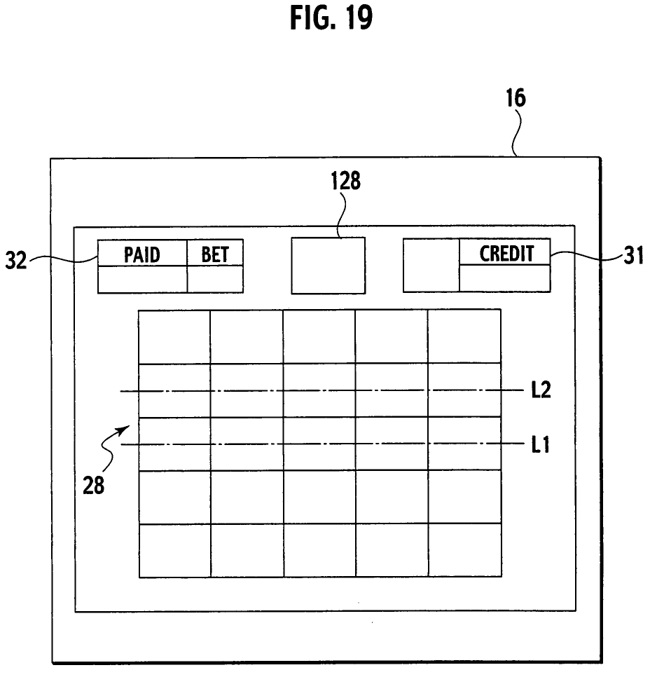

When it is determined in the step S11 shown in FIG. 17 that coins are bet, the main CPU 41 proceeds to step S111 and sets a payline according to the number of bet coins. For example, when a first coin is bet after the slot game process shown in FIG. 17 starts, the main CPU 41 sets the payline corresponding to one coin bet in the step S111. In this case, a payline L1 is set as shown in FIG. 18.

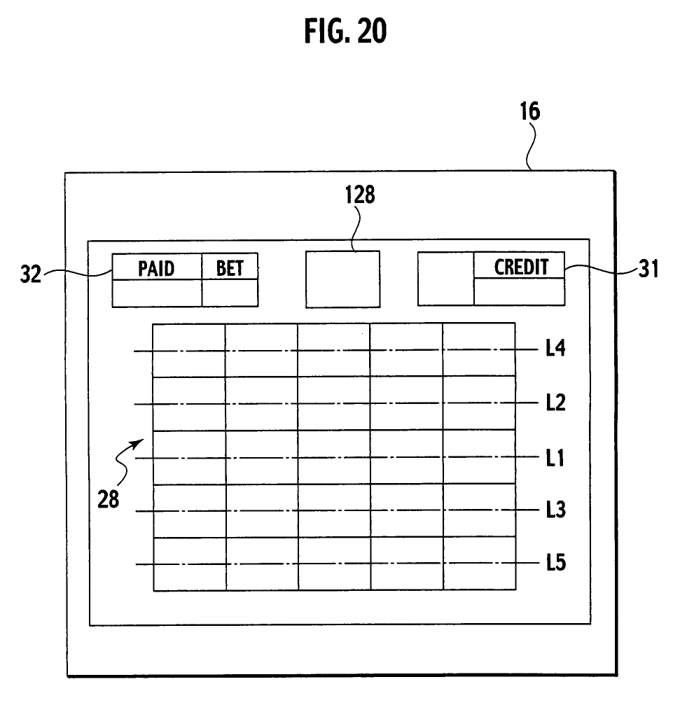

When the second coin is bet, the main CPU 41 sets a payline corresponding to two coin bet in the step S111. In this case, a payline L2 is set in addition to the payline L1 as shown in FIG. 19. In such a manner, the main CPU 41 sets the number of paylines according to the number of bet coins until the spin button is operated. In this embodiment, as shown in FIG. 20, the main CPU 41 increases the number of paylines in the order of paylines L2, L3, L4, and L5 each time the number of bet coins increases by one.

In the determination of the presence of a win in the step S116, the main CPU 41 determines whether the equal number of symbols of a type set in the payout table to the number in the payout table are aligned on the payline set in the step S111. When there are such symbols aligned on the payline, the main CPU 41 determines that a win is established. For example, as shown in FIG. 19, in the case where the two paylines L1 and L2 are set, it is determined that a win is established when the equal number of symbols of the type set in the payout table to the number set in the payout table are aligned on at least one of the two paylines. When determining that a win is established, the main CPU 41 pays out a number of coins according to the type and number of the symbols aligned on the set payline.

In the above described slot game with the payline set, when symbols of a same type set in the payout table stop on the set payline, a win is established, and these symbols are held. The held symbols are displayed so that the display style (color and brightness) thereof is different from that of the other symbols not held.

In the aforementioned embodiment, the description is given of the case where the brightness of the held symbols is controlled so as to be different from the brightness of the other symbols not held and the color of the held symbols is controlled according to the number n of plays of the hold game so as to be different from the color of the other symbols not held. For example, another display style may be applied instead, such as blinking the held symbols and changing the blinking speed according to the number n of plays of the hold game.

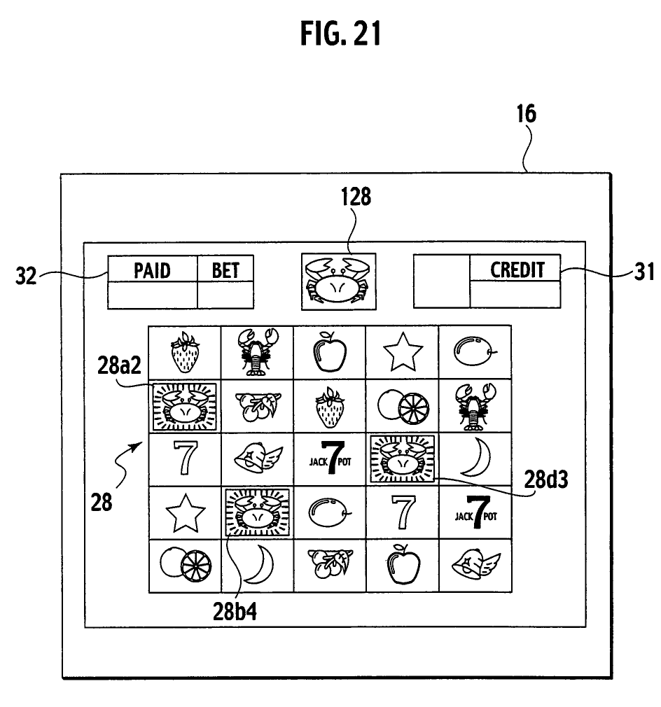

In the aforementioned embodiment, the description is given of the case where the display style of the held symbols is differentiated from that of the other symbols not held, but the present invention is not limited to this. For example, as shown in FIG. 21, the display style of the display regions 28a1, 28b4, and 28d3 may be changed, such as boxing with double lines the display regions 28a1, 28b4, and 28d3 where the held symbols are displayed.

In the aforementioned embodiment, the description is given of a case where a win is established when a same type of symbols stop in the display region. However, the condition to establish a win is not limited to this, and a win may be established when a combination of several types of symbols matches a predetermined combination. In this case, the combination of several types of symbols as the condition to establish a win only needs to be previously set in the payout table.

In the aforementioned embodiment, the description is given of the case where a same symbol as the held symbols is displayed in the region 128 outside of the reel frame while the color of the symbol is changed according to the number n of plays of the hold game. The present invention is not limited to this and may be configured to change size of the symbol displayed in the region 128. Specifically, the symbol is made smaller as the number of remaining plays decreases, thus expressing an image that the number of remaining plays decreases.

In the aforementioned embodiment, the description is given of the case where a same symbol as the held symbols is displayed in the region 128 outside of the reel frame while the color of the symbol is changed according to the number n of remaining plays of the hold games. The present invention is not limited to this and may be configured to change shape of the symbol displayed in the region 128. Specifically, the shape of the symbol is changed to a weaker image as the number of remaining plays decreases, thus transmitting the player that the number of remaining plays is reduced.

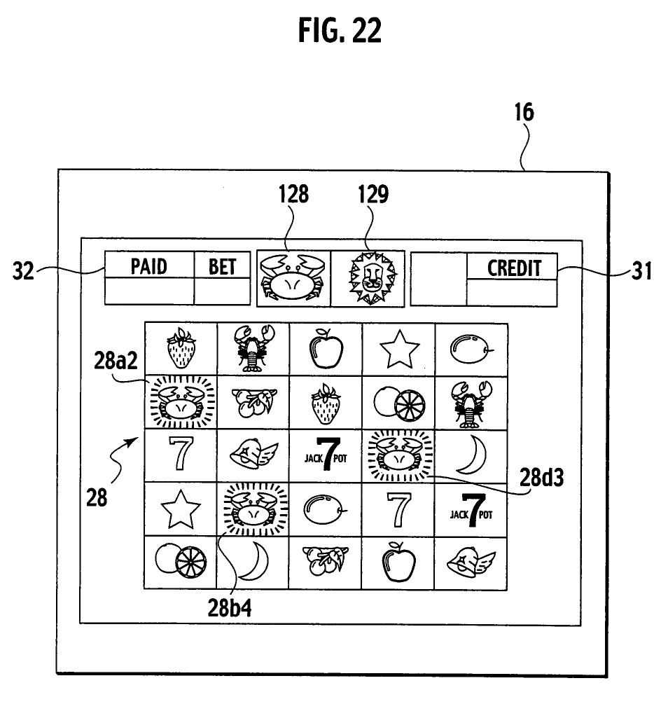

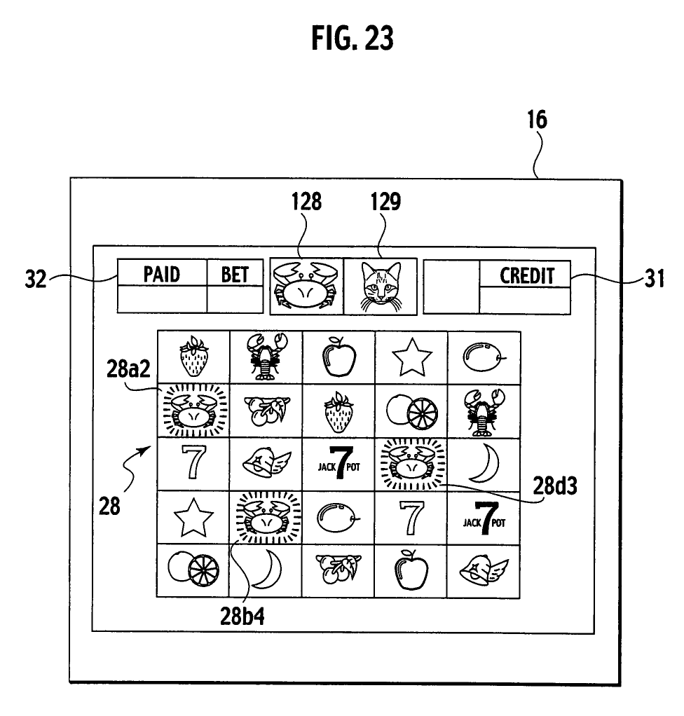

In the aforementioned embodiment, the description is given of the case where a symbol of the same type as the held symbols is displayed in the region 128 outside of the reel frame while the color of the symbol is changed according to the number n of remaining plays in the hold games. The present invention is not limited to this and may be configured to display different characters according to the number n of remaining plays in a region associated to the region 128. For example, when the number of remaining plays is not less than five, as shown in FIG. 22, an image of an lion is displayed in a region 129 associated with the region 128. When the number of remaining plays is less than five, as shown in FIG. 23, an image of a cat is displayed in the region 129. As the number n of remaining plays decreases, therefore, a character with a weaker image is displayed. Such a change in image can transmit the player that the number n of remaining plays is reduced.

What is claimed is:

1. A slot machine comprising:
a display on which arranged several types of symbols are rearranged; and
a controller which differentiates display of symbols satisfying a condition for payout among the several types of arranged symbols from display of the other symbols, and rearranges the symbols other than the symbols satisfying the condition for payout.

2. A slot machine comprising:
a display on which arranged several types of symbols are rearranged at each of a plurality of plays; and
a controller which repeats rearrangement of symbols other than symbols satisfying a condition for payout among the several types of arranged symbols at the plurality of plays and changes display of the symbols satisfying the condition for payout to display according to the number of remaining plays in which the rearrangement of the other symbols is repeated.

3. A slot machine comprising:
a display on which arranged several types of symbols are rearranged;
a controller which differentiates display of symbols satisfying a condition for payout among the several types of arranged symbols from display of the other symbols and executes a special game in which the rearrangement of the symbols other than the symbols satisfying the condition for payout is repeated; and
a switch to terminate the special game.

4. A slot machine comprising:
a display on which arranged several types of symbols are rearranged at each of a plurality of plays;
a controller which executes a special game in which rearrangement of symbols other than the symbols satisfying a condition for payout among the several types of symbols is repeated at the plurality of plays and changes display of the symbols satisfying the condition for payout to display according to the number of remaining plays in which the rearrangement of the other symbols is repeated; and
a switch to terminate the special game.

5. A slot machine comprising:
a display on which arranged several types of symbols are rearranged; and
a controller which differentiates brightness of symbols satisfying a condition for payout among the several types of arranged symbols from brightness of the other symbols and rearranges the symbols other than the symbols satisfying the condition for payout.

6. A slot machine comprising:
a display on which several types of arranged symbols are rearranged at each of a plurality of plays; and
a controller which repeats the rearrangement of symbols other than symbols satisfying a condition for payout among the several types of arranged symbols at the plurality of plays and changes color of the symbols satisfying the condition for payout to a color according to the number of remaining plays in which the rearrangement of the other symbols is repeated.

7. A slot machine comprising:
a display on which several types of arranged symbols are rearranged;
a controller which differentiates brightness of symbols satisfying a condition for payout among the several types of arranged symbols from brightness of the other symbols and executes a special game in which the symbols other than the symbols satisfying the condition for payout are rearranged; and
a switch to terminate the special game.

8. A slot machine comprising:
a display on which several types of arranged symbols are rearranged at each of a plurality of plays;
a controller which executes a special game in which rearrangement of symbols other than the symbols satisfying the condition for payout among the several types of arranged symbols is repeated at the plurality of plays and changes color of the symbols satisfying the condition for payout to a color according to the number of remaining plays in which the rearrangement of the other symbols is repeated; and
a switch to terminate the special game.

9. A slot machine comprising:
a display on which several types of arranged symbols are rearranged in a first region; and
a controller which displays a same symbol as symbols satisfying a condition for payout among the several types of arranged symbols in a second region which is different from the first region in addition to the first region and rearranges the symbols other than the symbols satisfying the condition for payout in the first region.

10. A slot machine comprising:
a display on which several types of arranged symbols are rearranged; and
a controller which differentiates display of display regions where symbols satisfying a condition for payout among the several types of arrange symbols from display of display regions where the other symbols are arranged and rearranges the symbols other than the symbols satisfying the condition for payout.

11. A playing method of a slot machine, comprising the steps of:
rearranging several types of symbols arranged on a display;
differentiating display of symbols satisfying a condition for payout among the several types of arranged symbols from display of the other symbols; and
rearranging the symbols other than the symbols satisfying the condition for payout.

12. A playing method of a slot machine, comprising the steps of:
rearranging several types of symbols arranged on a display at each of a plurality of plays;
repeating rearrangement of symbols other than symbols satisfying a condition for payout among the several types of arranged symbols at the plurality of plays; and
changing display of the symbols satisfying the condition for payout to display according to the number of remaining plays in which the rearrangement of the other symbols is repeated.

13. A playing method of a slot machine, comprising the steps of:
rearranging several types of symbols arranged on a display;
differentiating display of symbols satisfying a condition for payout among the several types of arranged symbols from display of the other symbols;
executing a special game in which the symbols other than the symbols satisfying the condition for payout are rearranged; and
terminating the special game based on a predetermined input operation.

14. A playing method of a slot machine, comprising the steps of:
rearranging several types of symbols arranged on a display at each of a plurality of plays;
executing a special game in which rearrangement of symbols other than symbols satisfying a condition for payout among the several types of arranged symbols is repeated at the plurality of plays;
changing display of the symbols satisfying the condition for payout to display according to the number of remaining plays in which the rearrangement of the other symbols is repeated; and
terminating the special game based on an input operation.

15. A playing method of a slot machine, comprising the steps of:
rearranging several types of symbols arranged on a display;
differentiating brightness of symbols satisfying a condition for payout among the several types of arranged symbols from brightness of the other symbols; and
rearranging the symbols other than the symbols satisfying the condition for payout.

16. A slot machine playing method, comprising the steps of:
rearranging several types of symbols arranged on a display at each of a plurality of plays;
repeating rearrangement of symbols other than symbols satisfying a condition for payout among the several types of arranged symbols at the plurality of plays; and
changing color of the symbols satisfying the condition for payout into a color according to the number of remaining plays in which the rearrangement of the other symbols is repeated.

17. A playing method of a slot machine, comprising the steps of:
rearranging several types of symbols arranged on a display;
differentiating brightness of symbols satisfying a condition for payout among the several types of arranged symbols from brightness of the other symbols;
executing a special game in which the symbols other than the symbols satisfying the condition for payout are rearranged; and
terminating the special game based on an input operation.

18. A playing method of a slot machine, comprising the steps of:
rearranging several types of symbols arranged on a display at each of a plurality of plays;
executing a special game in which rearrangement of symbols other than symbols satisfying a condition for payout among the several types of arranged symbols is repeated at the plurality of plays; and
changing color of the symbols satisfying the condition for payout to a color according to the number of remaining plays in which the rearrangement of the other symbols is repeated; and
terminating the special game based on a predetermined input operation.

19. A playing method of a slot machine, comprising the steps of:
rearranging several types of symbols arranged in a first region of a display;
displaying a same symbols as symbols satisfying a condition for payout among the several types of arranged symbols in a second region which is different from the first region in addition to the first region; and
rearranging the symbols other than the symbols satisfying the condition for payout in the first region.

20. A playing method of a slot machine, comprising the steps of:
rearranging several types of symbols arranged on a display;
differentiating display of display regions where symbols satisfying a condition for payout are arranged among the several types of arranged symbols from display of display regions where the other symbols are arranged; and
rearranging the symbols other than the symbols satisfying the condition for payout.
